(19) United States
(12) Patent Application Publication
(10) Pub. No.: US 2025/0153616 A1
(43) Pub. Date: May 15, 2025

(54) STOWABLE VEHICLE SEAT

(71) Applicant: Camaco, LLC, Farmington Hills, MI (US)

(72) Inventors: Jeff Carroll, West Bloomfield, MI (US); Pradeep Akkineni, Farmington Hills, MI (US)

(73) Assignee: Camaco, LLC, Farmington Hills, MI (US)

(21) Appl. No.: 18/948,426

(22) Filed: Nov. 14, 2024

Related U.S. Application Data
(60) Provisional application No. 63/599,415, filed on Nov. 15, 2023.

(51) Int. Cl. B60N 2/10; B60N 2/02; B60N 2/50

(52) U.S. Cl. CPC B60N 2/10; B60N 2/502; B60N 2/02253

(57) ABSTRACT

A stowable vehicle seat may include a seat back. A seat may include a seat bottom coupled to the seat back. A seat may include a supporting linkage configured to transition the seat between a use position and a stowed position, the supporting linkage comprising: one or more rear links pivotably coupled to the seat bottom and configured to pivotably couple to a vehicle floor at a rear link pivot point; and a break link pivotably coupled at a first end to the seat bottom at a first pivot point and configured to pivotably couple at a second end to the vehicle floor at a second pivot point, wherein a distance between the first pivot point and the second pivot point changes as the seat transitions between the use position and the stowed position.

### CROSS-REFERENCE TO RELATED PATENT APPLICATIONS

The present application claims the benefit of and priority U.S. Provisional Application No. 63/599,415, filed Nov. 15, 2023, the entire disclosure of which is herein incorporated by reference.

### BACKGROUND

The present application relates to seats for use in vehicles, and specifically to seats that fold for stowing to allow for expanded cargo room when the seats are not in use.

A typical motor vehicle includes seating for passengers and a rear compartment for carrying cargo. It is often desirable to adjust the number of passengers that a vehicle can accommodate or enlarge the cargo storage capacity. One potential solution is to provide seats that can be stowed in the floor of the vehicle such that the space previously occupied by the seats can be used to carry cargo, however this requires a substantial amount of space in the vehicle's floor, and the structure required for supporting and stowing seats can be complex and can itself reduce the amount of space available for carrying cargo when a seat is stowed. It would be advantageous to provide an improved vehicle seat that can be stowed in a smaller package and address one or more of the foregoing issues.

### SUMMARY

One embodiment relates to a stowable vehicle seat including: a seat back; a seat bottom coupled to the seat back; and a supporting linkage configured to transition the seat between a use position and a stowed position, the supporting linkage including: one or more rear links pivotably coupled to the seat bottom and configured to pivotably couple to a vehicle floor at a rear link pivot point; and a break link pivotably coupled at a first end to the seat bottom at a first pivot point and configured to pivotably couple at a second end to the vehicle floor at a second pivot point; wherein a distance between the first pivot point and the second pivot point changes as the seat transitions between the use position and the stowed position.

Another embodiment relates to a stowable vehicle seat including: a seat; and a supporting linkage configured to transition the seat between a use position and a stowed position, the supporting linkage including: a first rear link and a second rear link, each of the first and second rear links pivotably coupled to the seat and configured to pivotably couple to a vehicle floor; a first break link pivotably coupled to the seat at a first pivot point; a second break link pivotably coupled to the first break link and configured to pivotably couple to the vehicle floor at a second pivot point; and a distance between the first pivot point and the second pivot point defining a virtual link, wherein a length of the virtual link changes as the seat transitions between the use position and the stowed position.

Another embodiment relates to a method of stowing a vehicle seat including: providing a seat coupled to a floor of a vehicle via a supporting linkage including: one or more rear links pivotably coupled to the seat and pivotably coupled to the floor at a rear link point; and a break link pivotably coupled at a first end to the seat at a first pivot point and pivotably couple at a second end to the floor at a second pivot point; and applying a force to seat to transition the seat from a use position to a stowed position, wherein a distance between the first pivot point and the second pivot point changes as the seat moves between the use position and the stowed position.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a vehicle, according to an exemplary embodiment.

FIG. 2 is a perspective view of an internal structure for a seat of the vehicle of FIG. 1, including a seat back, a seat bottom, and a supporting linkage, according to an exemplary embodiment.

FIG. 3 is a front view of the internal structure for the seat of FIG. 2, according to an exemplary embodiment.

FIG. 4 is a back view of the internal structure for the seat of FIG. 2, according to an exemplary embodiment.

FIG. 5 is a right-side view of the internal structure for the seat of FIG. 2, according to an exemplary embodiment.

FIG. 6 is a left-side view of the internal structure for the seat of FIG. 2, according to an exemplary embodiment.

FIG. 7 is a perspective view of a break link of the linkage system for the seat of FIG. 2, according to an exemplary embodiment.

FIG. 8 is a right-side view of the internal structure for the seat of FIG. 2 coupled to a floor of the vehicle of FIG. 1, according to an exemplary embodiment.

FIGS. 9-15 and 17-18 are right-side views of the internal structure for the seat of FIG. 2 as the seat progresses from a use position to a stowed position, according to an exemplary embodiment.

FIG. 16 is a perspective view of the break link of FIG. 7 engaging with a bearing surface of the seat of FIG. 2, according to an exemplary embodiment.

FIG. 19 is a perspective view of a locking mechanism of the linkage system for the seat of FIG. 2, according to an exemplary embodiment.

FIGS. 20-32 are right-side views of the seat of FIG. 2, illustrating the motion of the seat as it progresses from a use position to a stowed position, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a seat assembly of the present disclosure includes a supporting linkage that facilitates stowing the seat in a floor of the vehicle. Specifically, the supporting linkage is designed such that the path of motion the seat travels as it transitions from use position to a stowed position in the floor is non-uniform, more compact, and at one stage substantially vertical to accommodate vehicle floors with limited free space for the seats.

It can be advantageous to stow rear seats of vehicle within the floor of the vehicle when the seats are not in use to increase the vehicle's cargo storage capacity. However, this can require a substantial amount of free space in the vehicle floor for the seats both move and rest in, and, particularly as modern vehicles transition to electric power trains and place a greater emphasis on vehicle size and weight, the amount of free space in the vehicle floor can be extremely limited. Advantageously, the seat assembly of the present disclosure includes one or more supporting links which change in length to impart a reduced, non-uniform path of motion culminating in a largely vertical stage, and thereby provide a seat assembly that can be stowed in a smaller window of space and accommodate more compact floor geometries.

### Vehicle and Passenger Cabin

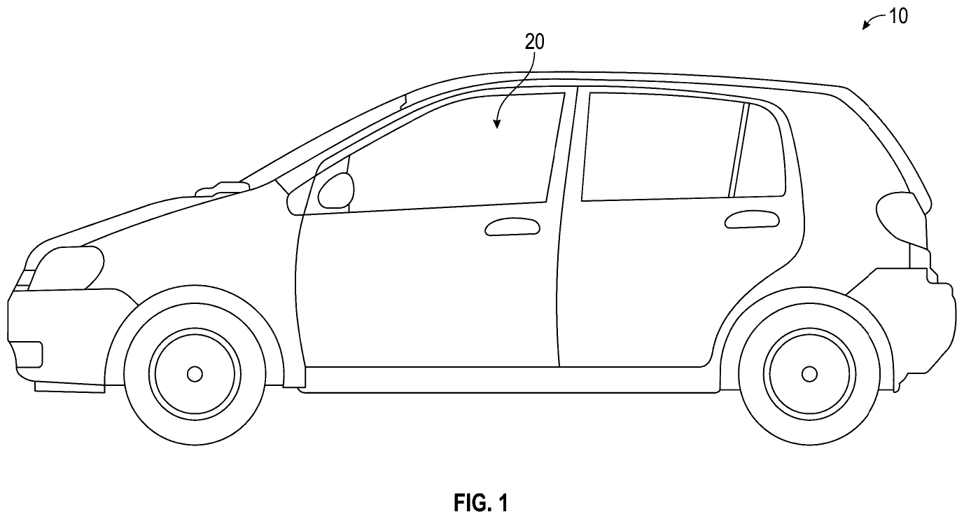

As shown in FIG. 1, a vehicle 10 includes an interior cabin, shown as passenger cabin 20. In one embodiment, the vehicle 10 is configured as an on-road vehicle such as a sedan, a sport utility vehicle (“SUV”), a pickup truck, a van, and/or still another type of passenger vehicle. In other embodiments, the vehicle 10 is configured as another type of on-road vehicle such as a semi-truck, a bus, or the like. In still other embodiments, the vehicle 10 is configured as an off-road vehicle such as construction machinery, farming machinery, or the like.

As discussed below, the cabin 20 can include one or more seats positionable from a use position to a stowed position in a tub of the vehicle floor to facilitate greater access and cargo capacity.

### Seat Assembly

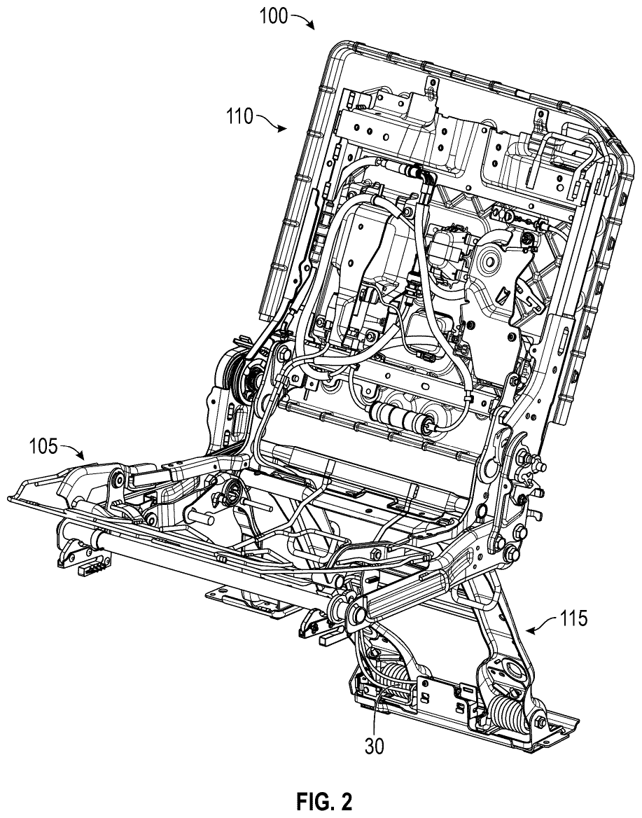

With reference to FIG. 2, a seat assembly 100 is shown, according to an exemplary embodiment. In some embodiments, one or more seat assemblies 100 may be positioned in the cabin 20 of the vehicle 10 to support passengers. The seat assembly 100 includes a seat bottom 105, a seat back 110, and a supporting linkage 115 coupling the seat bottom 105 to a floor 30 of the vehicle 10. The seat back 110 can be locked in a use position and may rotate from the use position to a stowed position (FIG. 10) independent of the supporting linkage 115.

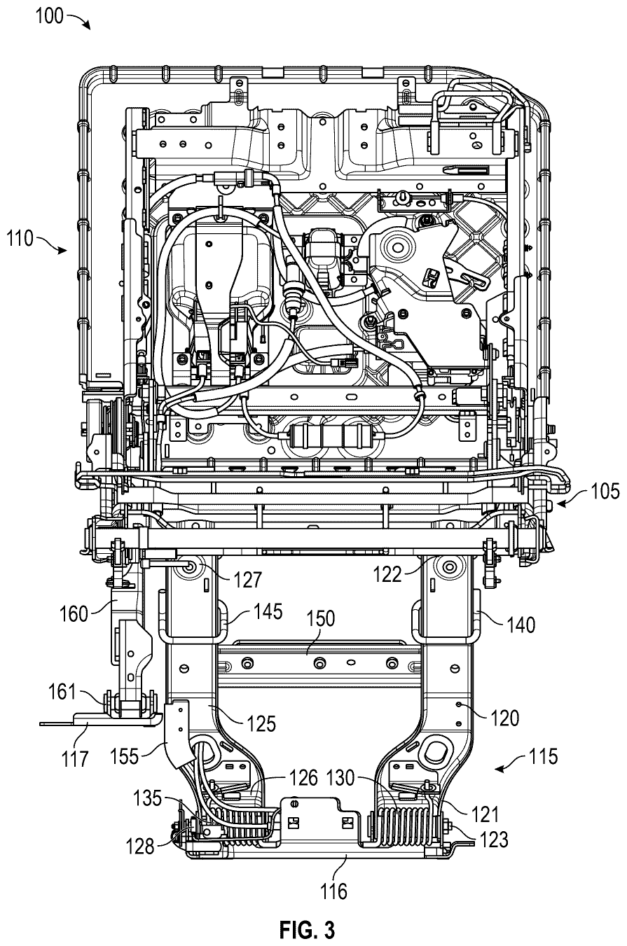

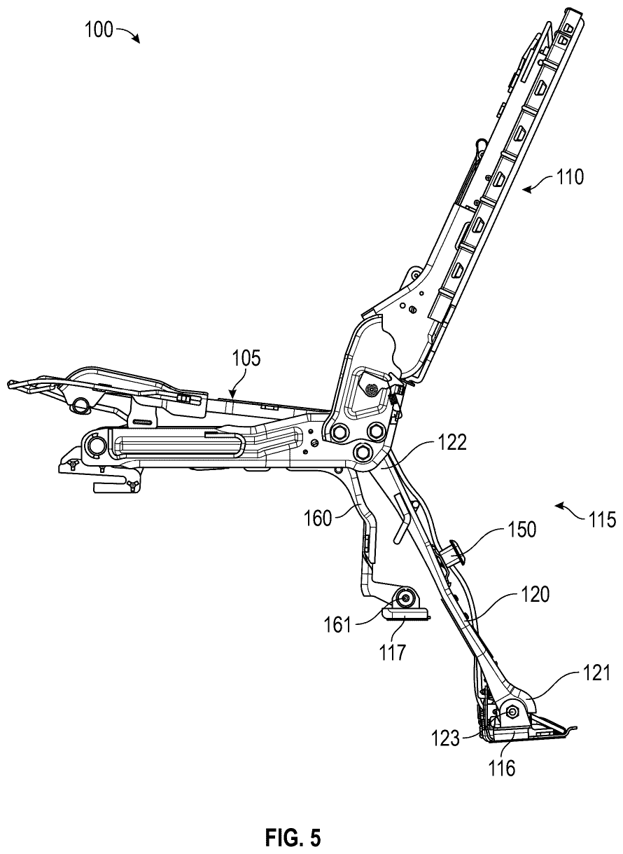

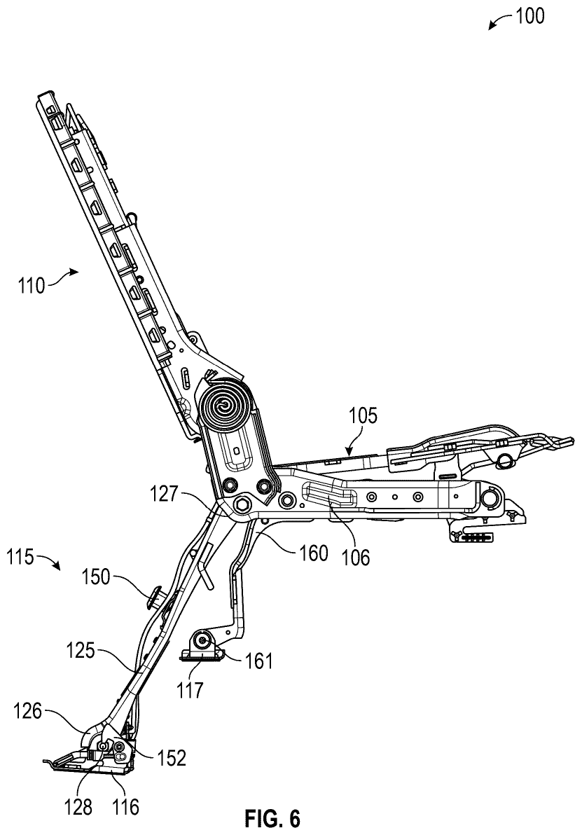

With additional reference to FIGS. 3-6, the supporting linkage 115 includes a first a first rear link 120, a second rear link 125, and a break link 160. The break link 160 includes two parts, a first link member 165 and a second link member 175. The first rear link 120 and the second rear link 125 are each pivotably (e.g., rotatably about an axis) coupled to the vehicle floor and to the seat bottom 105. The first link member 165 of the break link 160 is pivotably coupled to the seat bottom and to the second link member 175, and the second link member 175 is further pivotably coupled to the vehicle floor. As arranged, the seat assembly 100 forms a five-member linkage with a first member (e.g., one of the first rear link 120 or the second rear link 125), a second member (e.g., the seat bottom 105), a third member (e.g., the first link member 165), a fourth member (e.g., the second link member 175), and a fifth member (e.g., the vehicle floor).

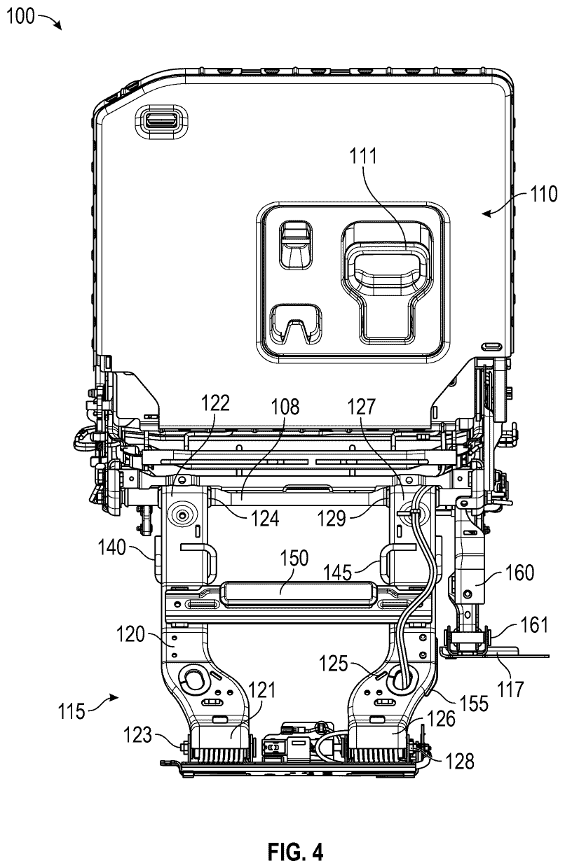

The first rear link 120 includes a first end 121 opposite a second end 122. The first end 121 is pivotably coupled at a first pivot location 123 to a bracket or support structure coupled to the vehicle floor 30, shown as first mounting plate 116. The first mounting plate 116 can be integrally formed or separate from and attached to the vehicle floor 30. At the first pivot location 123 a first spiral spring 130 is coupled to the first rear link 120 and the first mounting plate 116 to provide a bias force to the first rear link 120 to maintain the use position. The second end 122 is pivotably coupled at a second pivot location 124 to a rear frame member 108 of the seat bottom 105 (FIG. 4). The first rear link 120 is fixed to a first latch 140, which is removably, selectively coupled to a striker on the vehicle floor 30 to lock the first rear link 120 in an upright (i.e., “use”) position as shown in FIGS. 3-6. The striker may be a mechanically or electrically actuated locking assembly configured to secure and release the first latch 140 in response to a user input (e.g., a user pulling handle 111 on the rear of seat back 110) which may manually or electronically cause the striker to release the first latch 140.

The second rear link 125 similarly includes a first end 126 opposite a second end 127. The first end 126 is pivotably coupled at third pivot location 128 to the first mounting plate 116. The third pivot location 128 may be at the same height as the first pivot location 123. In some embodiments, the first pivot location 123 and the third pivot location 128 rotate around the same axis in the y-direction, which is perpendicular to the x-direction for the vehicle 10 across a width of the vehicle 10, from the driver side to the passenger side. The second end 127 is pivotably coupled at a fourth pivot location 129 to the rear frame member 108 of the seat bottom 105. At the third pivot location 128, a second spiral spring 135 is coupled to the second rear link 125 and the first mounting plate 116 to provide a bias force to the second rear link 125.

The first mounting plate 116 can be a unitary component coupling the first rear link 120 and the second rear link 125 or can be formed as two or more separate members. The first mounting plate 116 includes a locking hook or latch shown as hook 152. Hook 152 can be positioned on an exterior side of the second rear link 125 for receiving a locking pin of the supporting linkage 115 to lock the seat assembly 100 in the stowed position, as will be discussed in greater detail below. It should be appreciated that the hook 152 can be coupled to the first rear link 120 in the same manner. The hook 152 may rotate around an axis parallel to the axis of rotation at least one of the first rear link 120 and/or the second rear link 125. In some embodiments, the axis of rotation of the hook is forward in the x-direction of the axis of rotation of at least one of the first rear link 120 and/or the second rear link 125.

The second rear link 125 can be fixed to the vehicle by a second latch 145. The second latch 145 is removably coupled to a striker on the vehicle floor 30 to lock the second rear link 125 in an upright (use) position, as shown in FIGS. 3-6. The striker may be a mechanically or electrically actuated locking assembly configured to secure and release the second latch 145 in response to a user input (e.g., a user pulling handle 111 on the rear of seat back 110) which may manually or electronically cause the striker to release the second latch 145.

In some embodiments, a cross member 150 may extend between the first rear link 120 and the second rear link 125 at a point between the first ends 121, 126 and the second ends 122, 127. The cross member 150 can be integrally formed with one or both of the first rear link 120 and the second rear link 125 or formed as a separate member fixed to the first rear link 120 and the second rear link 125. For example the cross member 150 may be welded, bolted, or otherwise fixed to the first rear link 120 and the second rear link 125.

A wear plate or bearing surface 155 is coupled to a forward or front in the x-direction side of second rear link 125. It should be appreciated that the bearing surface 155 can be coupled to the first rear link 120 in the same manner. The bearing surface 155 can facilitate the non-uniform rotary motion of the seat assembly 100, as will be discussed in greater detail below.

The first rear link 120 and the second rear link 125 are fixed relative to one another and provide support to the seat bottom 105. The first rear link 120 and the second rear link 125 are coupled proximate to a rear of the seat bottom 105 in a front-back or x-direction of the vehicle, where the rear is towards the back of the vehicle relative to a front of the seat assembly 100. The first rear link 120 and the second rear link 125 are fixed on or near respective lateral sides of the seat assembly 100 in the right-left or y-direction of the vehicle. In the configuration shown in FIGS. 3-6, the first rear link 120 is positioned proximate a right or outboard side of the seat assembly 100 and the second rear link 125 is positioned proximate a left or inboard side of the seat assembly 100. The first pivot location 123 and the third pivot location 128 may be offset in y-direction relative to the second pivot location 124 and the fourth pivot location 129. For example, in the configuration shown in FIGS. 3-6, the first pivot location 123 and the third pivot location 128 are shown laterally inwards and closer to a center of the seat assembly 100 than the second pivot location 124 and the fourth pivot location 129. The first rear link 120 and the second rear link 125 can extend in the y-direction to couple the first pivot location 123 with the second pivot location 124 and the third pivot location 128 with the fourth pivot location 129, respectively.

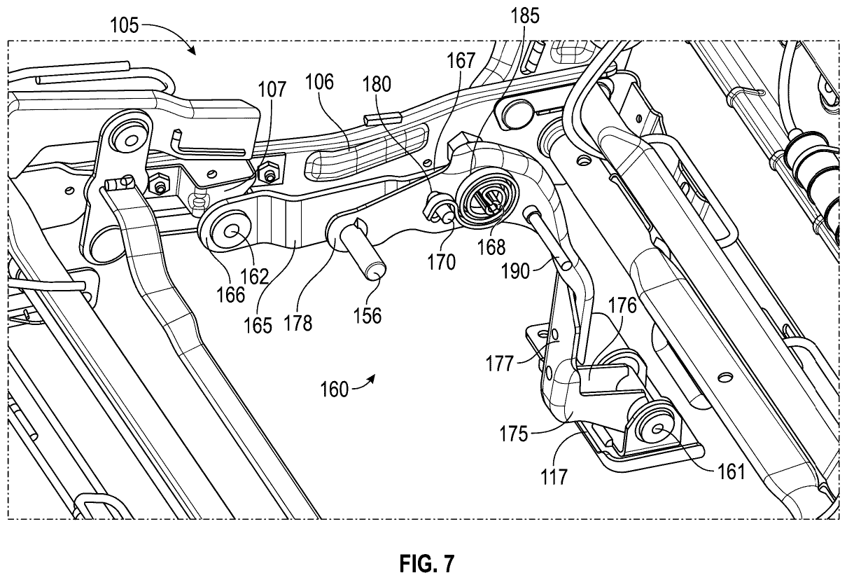

With additional reference to FIG. 7, the break link 160 is a two-member linkage which includes a first link member 165 and a second link member 175. The first link member 165 is pivotably coupled to the second link member 175. The first link member 165 is a substantially straight member and includes a first end 166 opposite a second end 167. The first end 166 is pivotably coupled at the first break link pivot 162 to a standoff 107 of the seat frame 106 of the seat bottom 105. The standoff 107 couples to an interior or medial side of the seat frame 106 and extends laterally inwards towards a center of the seat bottom 105 to set the first link member 165 inwards and apart from the seat frame 106. The second end 167 is pivotably coupled at the second break link pivot 168 to the second link member 175. The second link member 175 includes a first end 176, a middle portion 177, and a second end 178.

In the use position shown in FIGS. 3-7, the first end 176 and the second end 178 extend substantially in the front-back or x-direction of the vehicle, and the middle portion 177 extends substantially vertically or in the z-direction of the vehicle, such that the second link member 175 forms an approximate Z shape. It will be appreciated, however, that other profiles and orientations of the first end 176, the middle portion 177, and the second end 178 are contemplated herein. In some embodiments, the total shape of the second link member 175 can be configured to accommodate the floor of the vehicle. The second link member 175 can be unitary or formed of multiple pieces coupled together.

The first end 176 is substantially L-shaped and is pivotably coupled at the fifth pivot location 161 to a bracket or support structure coupled to the vehicle floor 30, shown as second mounting plate 117.

The second end 178 of the second link member 175 includes a guide pin 156 extending laterally inwards away from the seat frame 106 and towards a center of the seat assembly 100. The guide pin 156 is fixed to the second link member 175 and is configured to engage the bearing surface 155 of the second rear link 125, as will be discussed in greater detail below. The second end 178 of the second link member 175 is substantially hook-shaped, with the eye of the hook facing towards a front of the seat assembly 100, and includes an slot 180 configured to receive a spring pin 170 coupled to the first link member 165. The slot 180 is arcuate and extends along an arc centered at the second break link pivot 168. The slot 180 is positioned on the second link member 175 between the second end 178 and the second break link pivot 168. In the use position, the spring pin 170 is positioned proximate a top of the slot 180 (e.g., nearest the seat bottom 105). The spring pin 170 is fixed relative to the first link member 165 and extends through the slot 180 of the second link member 175 to engage with a free end of the clock spring 185. Clock spring 185 is axially centered at the second break link pivot 168 to provide a biasing force against the spring pin 170. The biasing force is used to prevent the first link member 165 from collapsing as the seat assembly 100 transitions from the use position to the stowed positioned, as will be discussed in greater detail below. The middle portion 177 couples the L-shaped first end 176 to the hook-shaped second end 178. The spring pin 170 and the slot 180 form a stop or rotation restriction assembly, in this case a pin-slot joint to limit the rotation of the first link member 165 and the second link member 175 relative to each other. The length of the slot 180 controls the amount one of the first link member 165 or the second link member 175 can rotate relative to the other. In some embodiments, the slot 180 limits relative rotation between the first link member 165 and the second link member 175 to less than 360 degrees. In some embodiments, the slot 180 limits relative rotation between the first link member 165 and the second link member 175 to less than 90 degrees. In some embodiments, the slot 180 limits relative rotation between the first link member 165 and the second link member 175 to between 0 and 45 degrees. In some embodiments, the slot 180 limits relative rotation between the first link member 165 and the second link member 175 to between 10 degrees and 30 degrees. Other stops or rotation restrictions assemblies may be used without department from the scope of invention including tabs, channels, guides, etc.

The second link member 175 includes a locking pin 190. The locking pin 190 extends laterally inwards away from the seat frame 106, and is positioned between the second break link pivot 168 and the first end 176 of the second link member 175. The locking pin 190 engages with the hook 152 to lock the seat assembly 100 in the stowed position.

In some embodiments, the break link 160 can be positioned forward in the x-direction of the first rear link 120 and the second rear link 125. The fifth pivot location 161 (e.g., pivot axis) can be positioned forward of the first pivot location 123 and the second pivot location 124 and vertically higher in the z-direction of the first pivot location 123 and the second pivot location 124. The first break link pivot 162 can be positioned forward of the second pivot location 124 and the fourth pivot location 129, such that in the x-direction of the vehicle the break link 160 is positioned forward of the first rear link 120 and the second rear link 125. The break link 160 is positioned laterally inboard closer to a center of the vehicle of the second rear link 125, such that in the y-direction of the vehicle the first rear link 120, the second rear link 125, and the break link 160 are positioned at different locations along a width of the seat bottom 105.

The rotatable couplings at the pivot locations (e.g., first pivot location 123, second pivot location 124, third pivot location 128, fourth pivot location 129, fifth pivot location 161, first break link pivot 162, second break link pivot 168) can each be a hinge joint or cylindrical joint with one degree of rotational freedom such that the coupled members can rotate relative to one of the others about an axis of rotation.

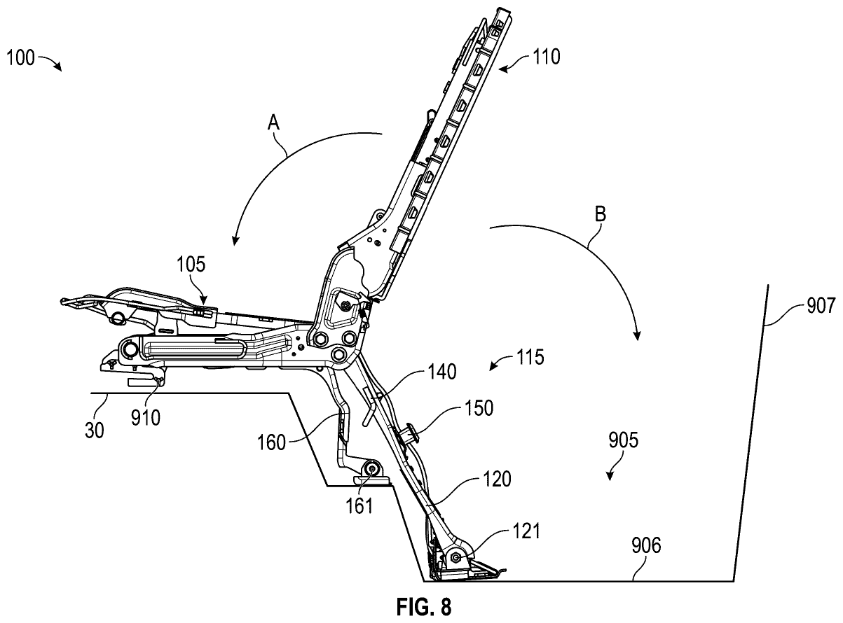

As shown in FIG. 8, the seat assembly 100 is coupled to the floor 30 of the vehicle 10. In FIG. 8, the seat assembly 100 is shown upright in the use position. The supporting linkage 115 supports the seat bottom 105 and seat back 110. Strikers 910 coupled to a bottom of the seat bottom 105 can engage with latches on the floor 30 and the first latch 140 and the second latch 145 can similarly engage with strikers on the floor 30 to secure and maintain the seat assembly 100 in the use position.

The floor 30 can vary in the z-direction of the vehicle such that the first mounting plate 116 and the second mounting plate 117 couple to the floor 30 at different heights. The first end 121 of the first rear link 120 and the first end 126 of the second rear link 125 are coupled to the first mounting plate 116 in a tub 905 formed by the floor 30. The tub 905 extends behind the seat assembly 100 in the x-direction of the vehicle 10. One or more of the first rear link 120, the second rear link 125, and the break link 160 pivotably couple to the first mounting plate 116 rearward in the x-direction of the seat bottom 105, such that the seat bottom 105 is cantilevered relative to the mounting points of one or more or all of the first rear link 120, the second rear link 125, and the break link 160. The tub 905 includes a floor 906 and a rear wall 907. Due to the specific geometry of the floor 30 and the tub 905 shown in FIG. 8, the seat assembly 100 would hit the rear wall 907 if folded backwards into the tub 905 along a constant or uniform arc of motion. To avoid contact with the rear wall 907 and collapse fully into the tub 905, the supporting linkage 115 therefore imparts a non-uniform rotary motion to the seat assembly 100.

In transitioning from the use position to the stowed position, the seat back 110 folds down in direction A towards the seat bottom 105. The seat bottom 105 and folded seat back 110 then rotate in non-uniform rotatory motion in the direction of B due to the supporting linkage 115, backwards in the x-direction of the vehicle and into the tub 905. As described above, the non-uniform motion of the seat assembly 100 allows the seat to avoid the rear wall 907. It should be understood that the direction B does not describe the actual path of motion of the seat assembly 100 and instead represents a general direction the seat assembly 100 travels in. The non-uniform motion of the seat assembly 100 may include a non-uniform rotary section and a substantially vertical section as described herein.

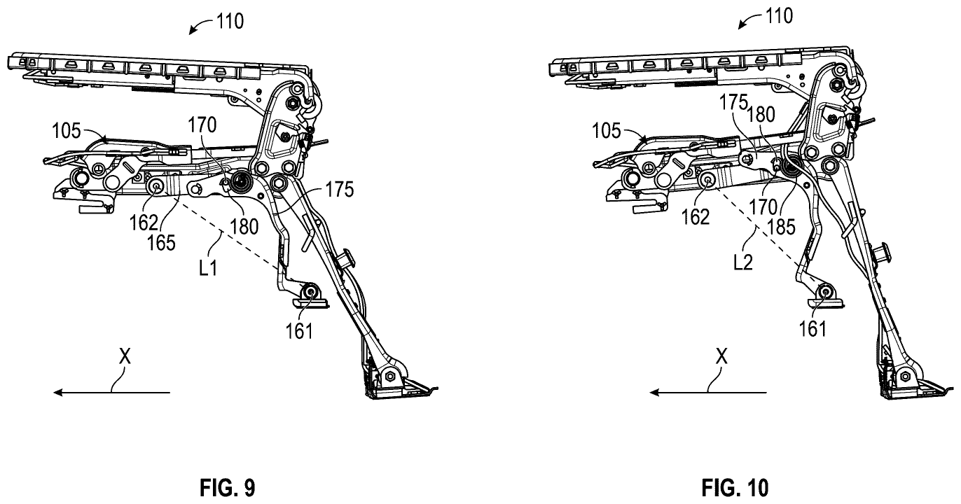

With additional reference now to FIGS. 9-15 and 17-18, the transition of the seat assembly 100 from the use position (FIG. 8) to the stowed position (FIG. 18) is shown. FIGS. 9-15 and 17-18 depict a cross-section of the seat assembly 100 to illustrate the movement of the break link 160 of the supporting linkage 115. Referring initially to FIG. 9, the seat assembly 100 is shown with the seat back 110 folded down onto the seat bottom 105. A distance between the fifth pivot location 161 and the first break link pivot 162 is referred to as virtual link 164. L1 represents the length of the virtual link 164 in the supporting linkage 115 which due to the configuration of the break link 160 will change as the seat assembly transitions from the use position to the stowed position and thereby at least partially be responsible for causing the non-uniform rotary motion of the seat assembly 100 as the seat assembly 100 transitions from the use position to the stowed position.

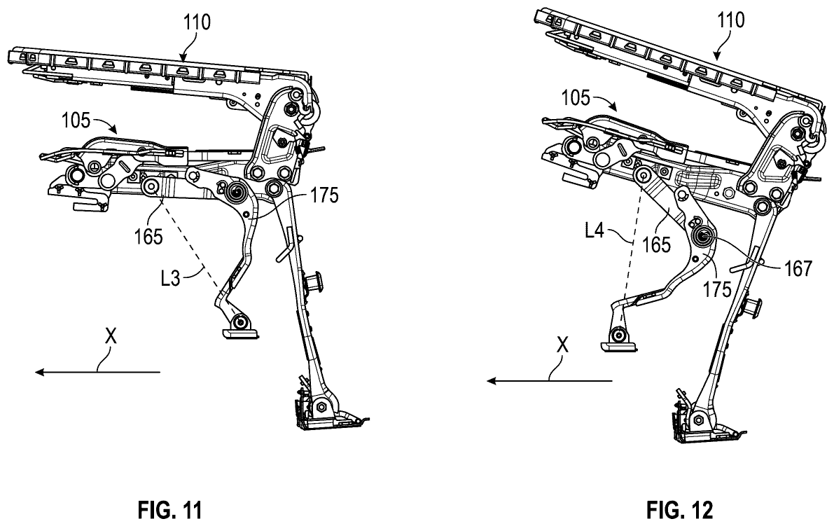

In the exemplary position of the seat assembly 100 shown in FIG. 4, the seat assembly 100 is shown in the use position. In the use position, the spring pin 170 is positioned at or proximate to a top of the slot 180. To position the seat in the stow position, a force or load is imparted on the seat assembly 100 generally rearward in the x-direction. The first link member 165 rotates counter-clockwise around the first break link pivot 162 slightly upwards in the z-direction, such that the spring pin 170 moves to the bottom of the slot 180 as shown in FIG. 11. In FIG. 10, the length of the virtual link 164 between the fifth pivot location 161 and the first break link pivot 162 is shown as length L2. L2 is shorter than L1 due to the rotation of the first link member 165 relative to the second link member 175. It should be noted that the clock spring 185 is not animated in FIGS. 9-15 and 17-18, however the free end of the clock spring 185 remains in contact with the spring pin 170 (though not shown). The changing distance between the fifth pivot location 161 and the first break link pivot 162 results in non-uniform motion of the seat assembly 100.

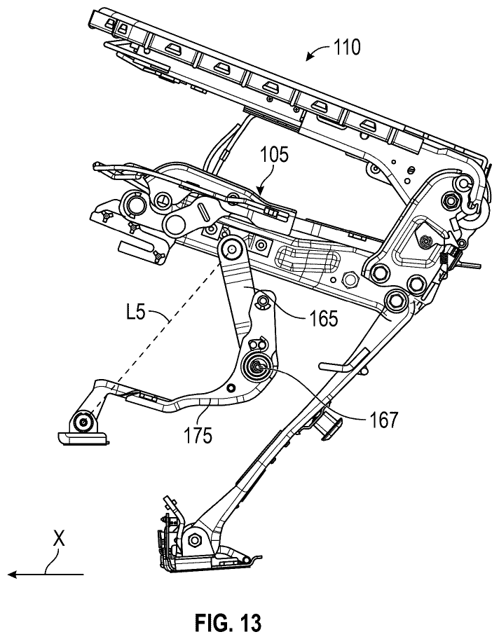

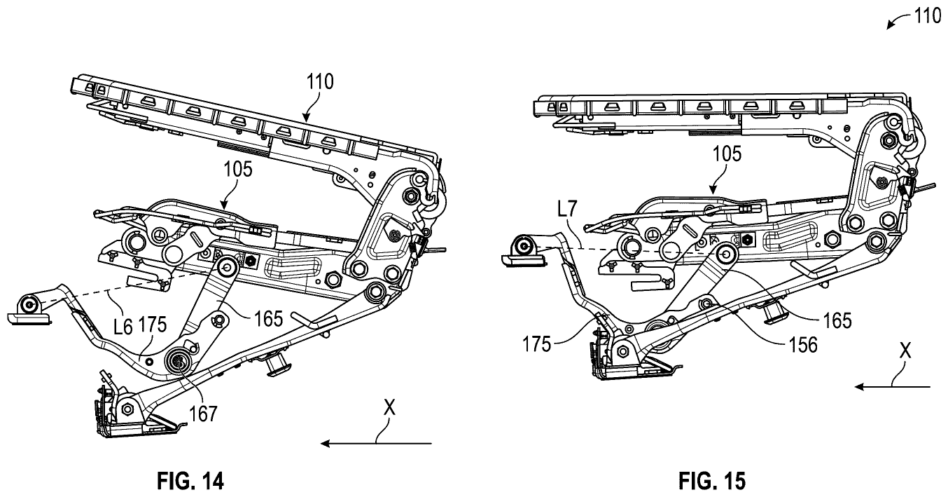

In pivoting the seat assembly 100 rearward in the x-direction into the tub 905, the first link member 165 rotates counterclockwise (from the perspective of FIG. 9) around the first break link pivot 162 while the second link member 175 rotates clockwise around the fifth pivot location 161. Referring now to FIGS. 11 and 12, the first link member 165 reveres rotational direction and begins to rotate clockwise and generally down in the z-direction of the vehicle, and the length of the virtual link 164 between the fifth pivot location 161 and the first break link pivot 162 continues to shrink, as represented by L3 and L4 respectively. With reference now to FIGS. 13 and 14, this, in turn, allows, at least in part, for the seat assembly 100 to experience non-uniform motion that brings a front of the seat assembly 100 lower as it moves rearward. The first spiral spring 130 and the second spiral spring 135 provide a biasing force on the first rear link 120 and the second rear link 125 in a counterclockwise direction that is greater than the weight of the seat assembly 100 pushing down on the first rear link 120 and the second rear link 125. As the first spiral spring 130 and second spiral spring 135 hold the up the first rear link 120 and the second rear link 125, a front of the seat assembly 100 rotates forward. The center of mass of the seat assembly 100 having moved rearward now imparts a force on the spring pin 170 to compress the clock spring 185 and move to the other (previously top) end of the slot 180. At this point, the seat assembly 100 begins to move substantially down in the z-direction in addition to moving rearward in the x-direction. At FIG. 14 the first link member 165 continues to rotate clock-wise and now upwards in the z-direction, having rotated from behind the first break link pivot 162 to in front of the first break link pivot 162.

Referring now to FIGS. 15-18, a vertical stage of the non-uniform motion of the seat assembly 100 is shown. As discussed above, the geometry of the tub 905 and the position of the rear wall 907 limit the path of motion the seat assembly 100 can travel to transition to the stow position. To avoid contact with the rear wall 907, the supporting linkage 115 imparts a non-unform rotary motion to the seat assembly 100. The non-uniform rotary motion includes a largely vertical final stage, wherein the majority of the movement is in the z-direction as opposed to the x-direction. As part of this motion, the first spiral spring 130 and the second spiral spring 135 provide a biasing force on the first rear link 120 and the second rear link 125 in a counter-clockwise direction that is greater than the weight of the seat assembly 100 pushing down on the first rear link 120 and the second rear link 125, thereby holding up the seat assembly 100. A user applies an additional vertical force down in the z-direction to overcome the spring biasing force and complete the transition to the stow position. In some embodiments, a motor and gear assembly can be used to automate the transition, as will be discussed in greater detail below.

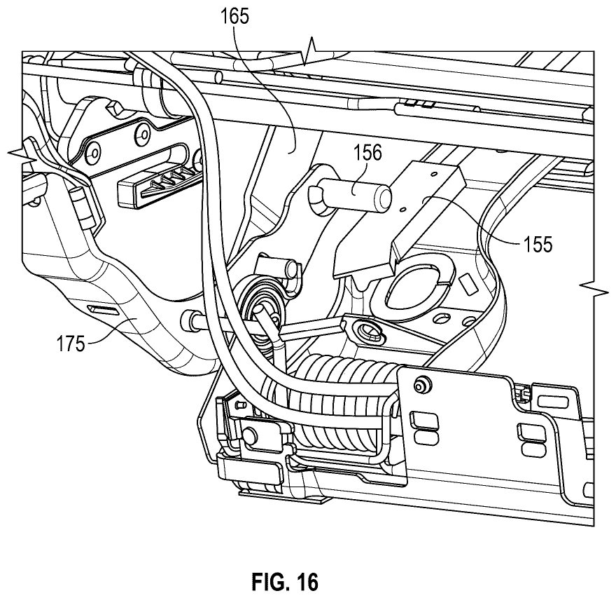

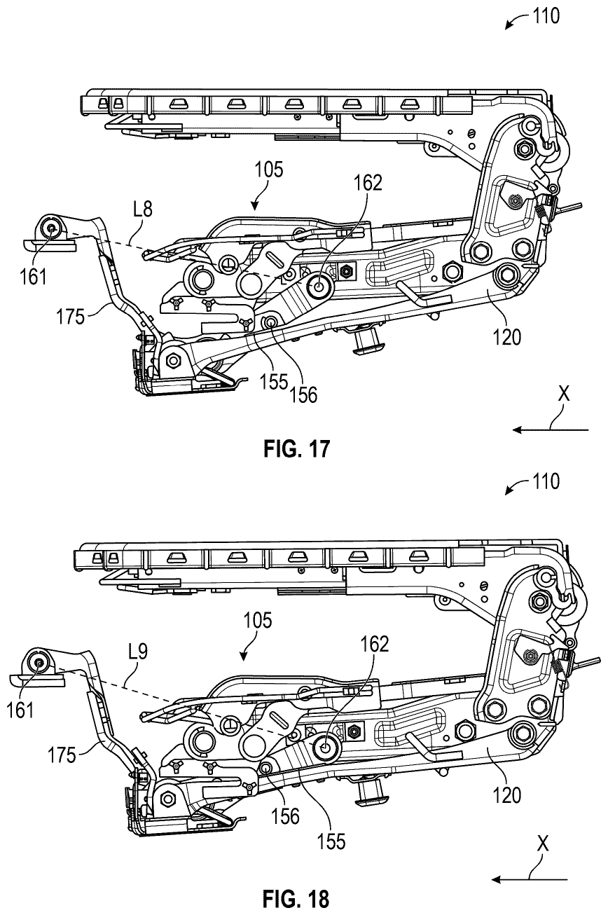

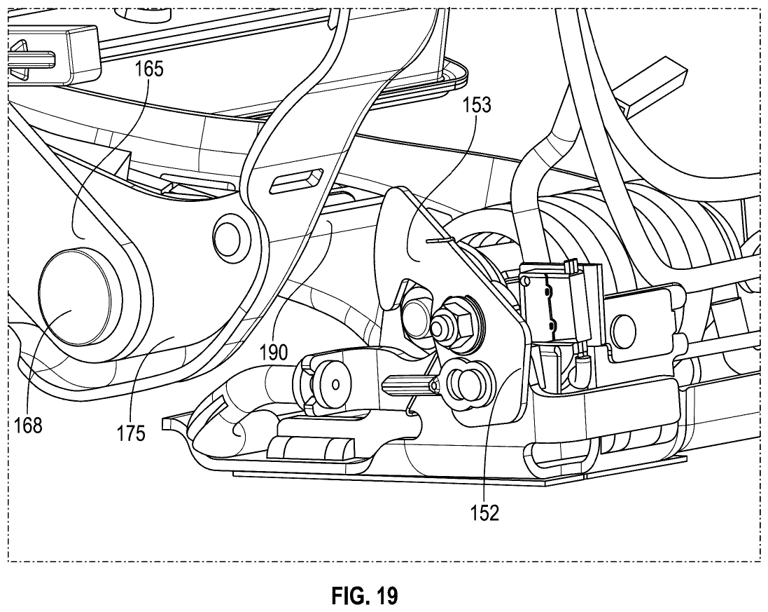

Referring still to FIGS. 15-18, the break link 160 includes a guide pin 156 extending laterally inwards towards a center of the seat assembly 100. The guide pin 156 extends inward to overlap in the width or y-direction the bearing surface 155 of the second rear link 125. As can be seen in FIGS. 15 and 16, in the vertical stage the guide pin 156 engages with the bearing surface 155. The bearing surface 155 imparts a force substantially in the x-direction of the vehicle towards a front of the seat assembly 100. This, in turn, pushes the break link 160 forwards in the x-direction, at least partially counteracting the x-direction component of the rotation of the seat assembly such that the seat back 110 and seat bottom 105 move substantially vertically down into the tub 905. The guide pin 156 and bearing surface 155 thereby keep the seat assembly 100 substantially level in the largely vertical stage as the seat assembly 100 completes the transition to the stow position. As discussed above, due to the position of the rear wall 907, to transition from the use position to the stow position (and vice versa) the supporting linkage 115 imparts non-uniform rotation, including the vertical stage as represented by FIGS. 15-18, onto the seat assembly 100 in order to avoid interference of the rear wall 907. FIGS. 17 and 19 illustrate the substantially vertical movement of the seat assembly 100 in the final stage as the guide pin 156 slides along the bearing surface 155. The break link 160 continues to fold until the first link member 165 lies substantially parallel with the seat frame 106.

In prior stowable seat designs, due to the fixed length of the linkages in the stow mechanism, the path taken by the seat assembly is substantially uniform and lacks a vertical stage at the end, causing the seat assembly 100 to require a larger tub to stow into. The changing length of the virtual link 164 due to the arrangement of the break link 160 allows for the non-uniform rotary motion of the supporting linkage 115 which can allow the seat assembly 100 to stow into tubs otherwise not fit for a stowable seat.

As shown in FIG. 19, upon transitioning the seat assembly 100 into the stow position, the locking pin 190 of the break link 160 engages with an outer camber 153 of the hook 152 to actuate the hook 152 until it latches onto the locking pin 190, thereby locking the seat assembly 100 in the stow position.

In some embodiments, a motor and gear box assembly can be provided at the fifth pivot location 161 to actuate the break link 160. The movement of the break link 160 can thereby control the seat to transition from the use position to the stow position and vice versa.

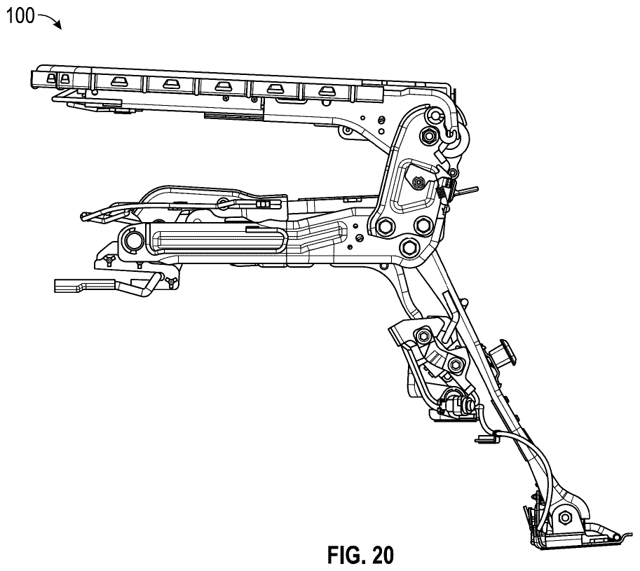

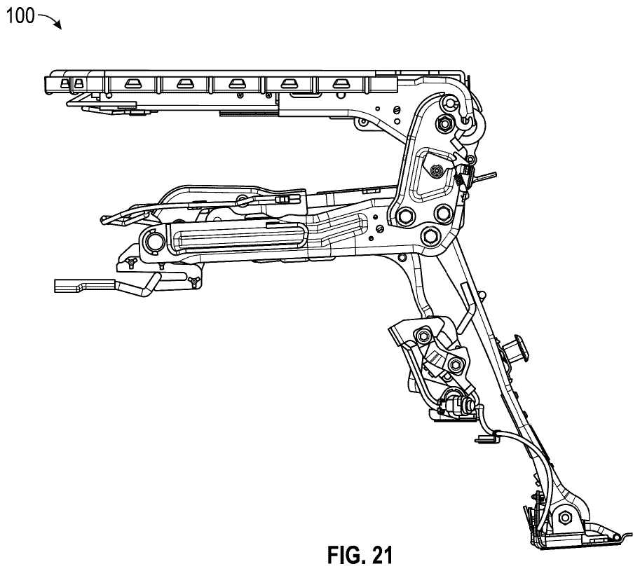

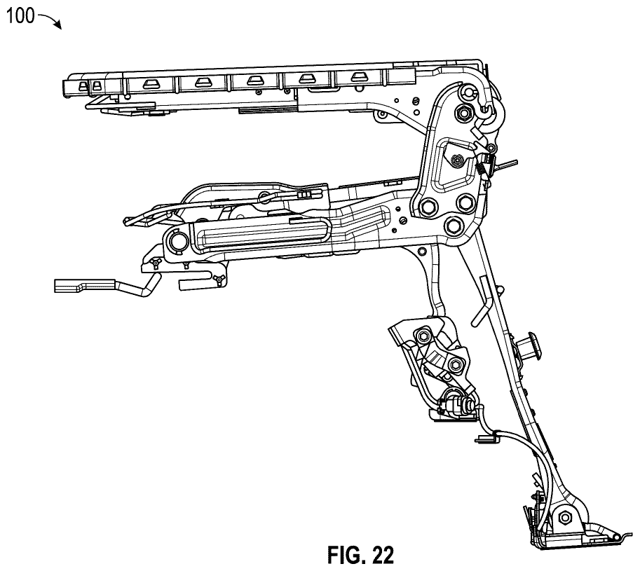

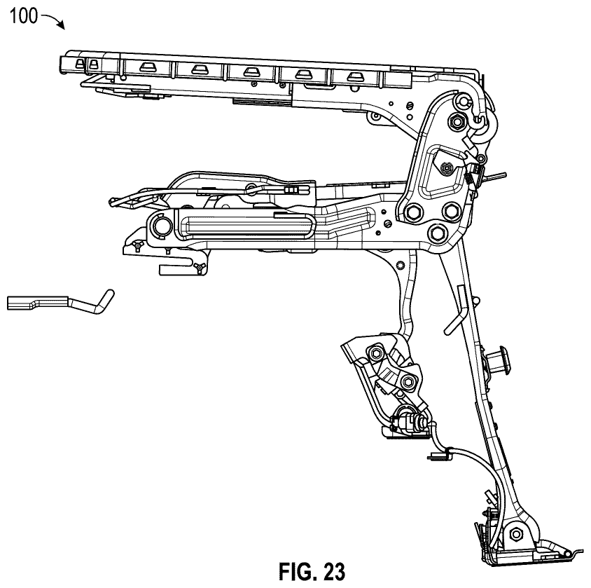

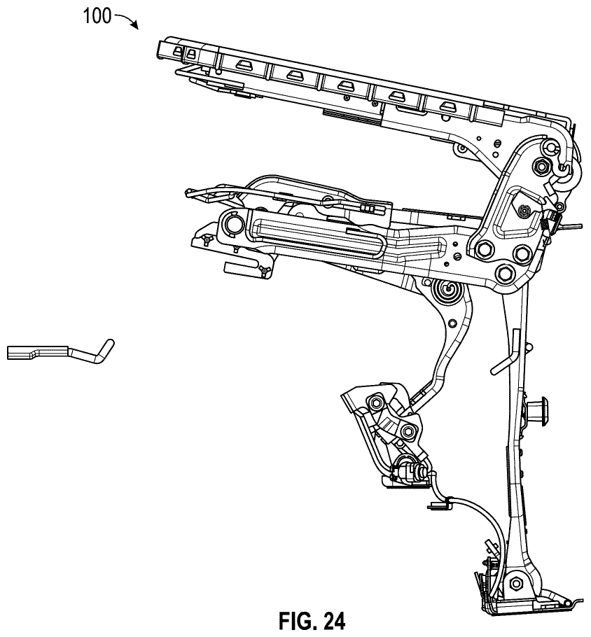

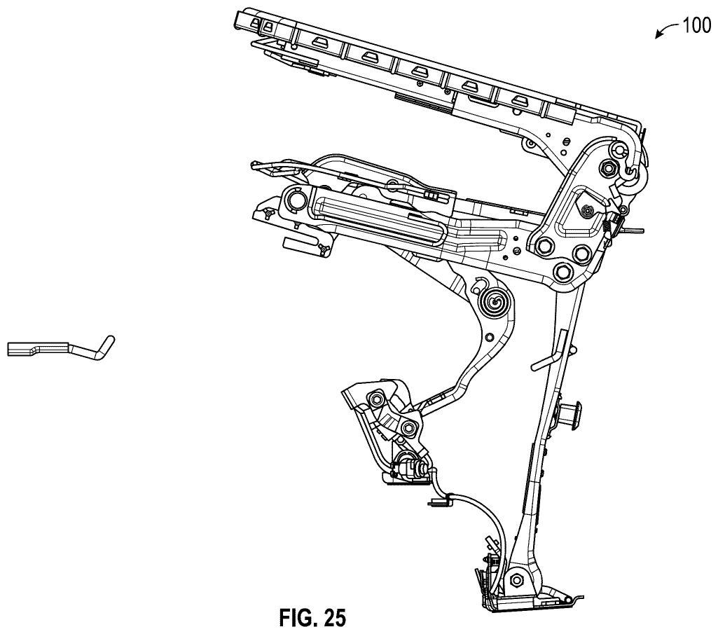

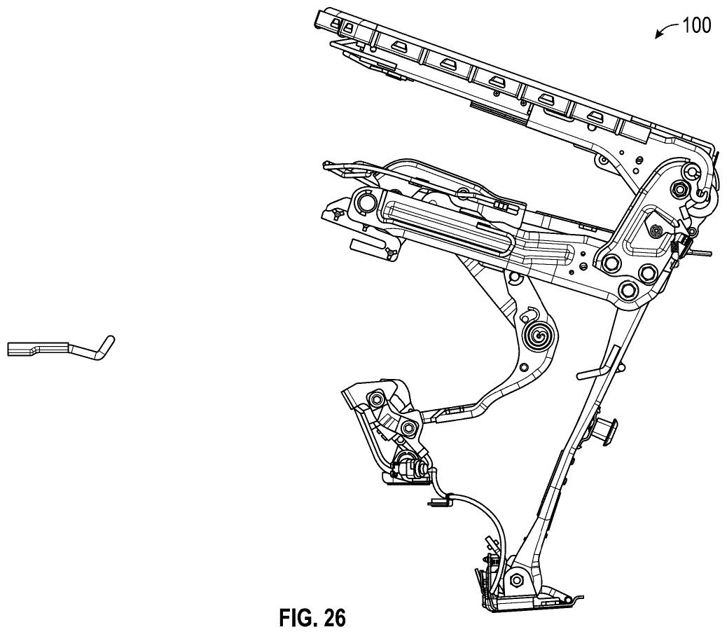

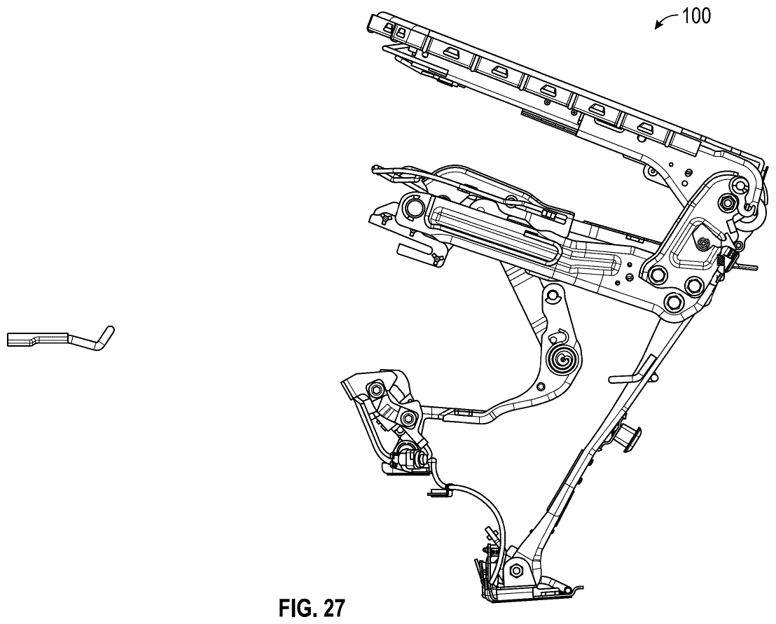

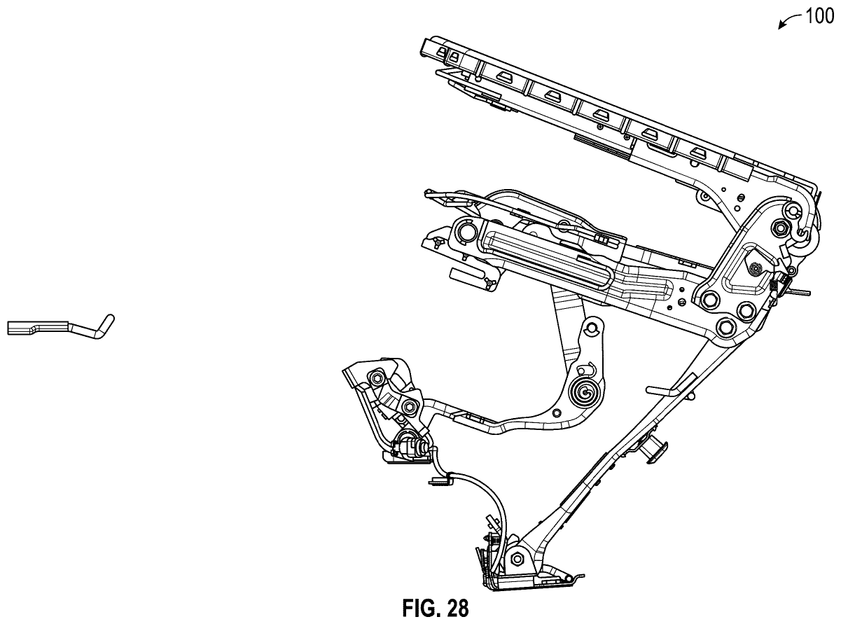

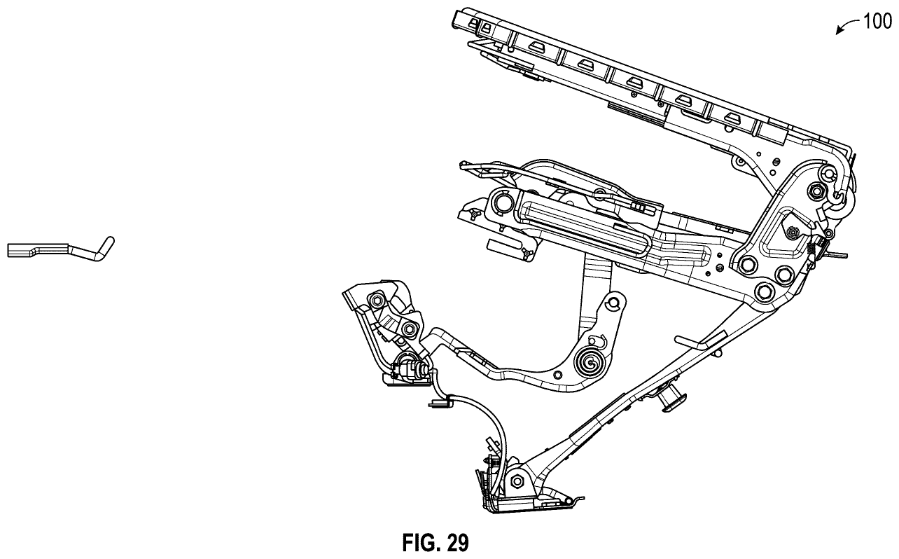

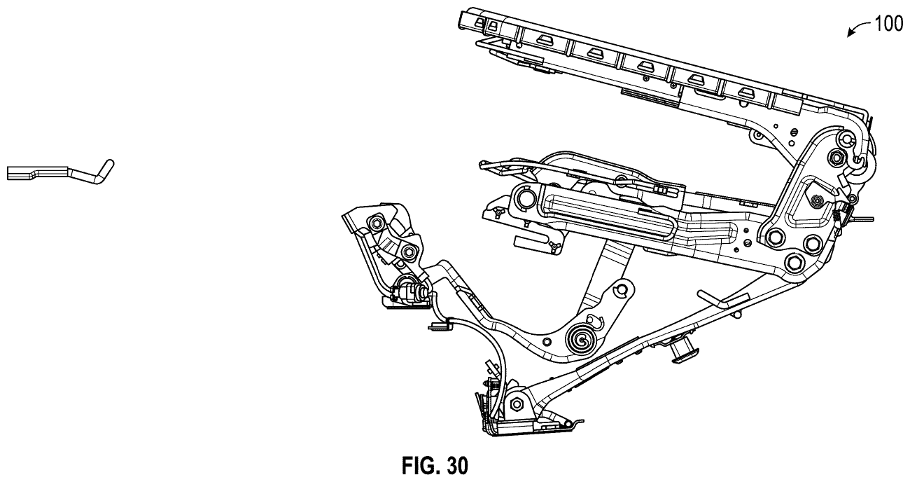

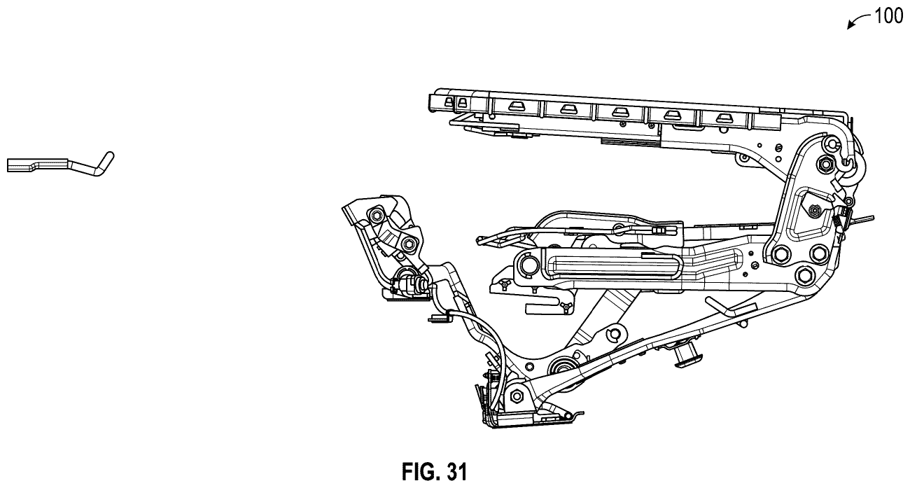

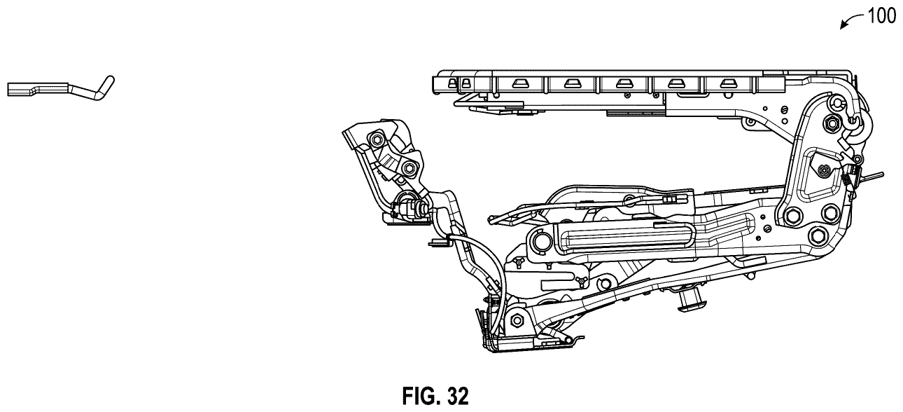

Referring now to FIGS. 20-32, the seat assembly 100 is shown transitioning from an upright position, wherein the seat back 110 is folded down (FIG. 20), to a stow position (FIG. 32). The progression of FIGS. 20-32 illustrate the motion of the seat assembly 100.

As utilized herein, the terms “approximately,” “about,” “substantially”, and similar terms are intended to have a broad meaning in harmony with the common and accepted usage by those of ordinary skill in the art to which the subject matter of this disclosure pertains, and mean +/−10% from the given value or direction. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Language such as the phrases “at least one of X, Y, and Z” and “at least one of X, Y, or Z,” unless specifically stated otherwise, are understood to convey that an element may be either X; Y; Z; X and Y; X and Z; Y and Z; or X, Y, and Z (i.e., any combination of X, Y, and Z). Thus, such language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the seat assembly 100, the break link 160, and the components thereof as shown in the various exemplary embodiments is illustrative only. Additionally, any element disclosed in one embodiment may be incorporated or utilized with any other embodiment disclosed herein.

1. A stowable vehicle seat comprising:
a seat back;
a seat bottom coupled to the seat back; and
a supporting linkage configured to transition the seat between a use position and a stowed position, the supporting linkage comprising:
one or more rear links pivotably coupled to the seat bottom and configured to pivotably couple to a vehicle floor at a rear link pivot point; and
a break link pivotably coupled at a first end to the seat bottom at a first pivot point and configured to pivotably couple at a second end to the vehicle floor at a second pivot point;
wherein a distance between the first pivot point and the second pivot point changes as the seat transitions between the use position and the stowed position.

2. The seat of claim 1, wherein the break link is coupled to the seat bottom forward of the one or more rear links.

3. The seat of claim 1, the break link comprising:
a first segment pivotably coupled to the seat bottom at the first pivot point; and
a second segment pivotably coupled to the first segment at a third pivot point and configured to pivotably couple to the vehicle floor at the second pivot point.

4. The seat of claim 3, the break link further comprising a stop configured to limit relative rotation between the first segment and the second segment to between 0 degrees and 45 degrees.

5. The seat of claim 3, the break link further comprising a stop configured to limit relative rotation between the first segment and the second segment, the stop comprising:
a pin coupled to the first segment; and
a slot in the second segment to receive the pin, wherein the pin moves along the slot as the seat transitions from the use position to the stowed position.

6. The seat of claim 5, further comprising:
a spring coupled to the second segment and the pin and configured to bias the pin down when the seat is in the use position.

7. The seat of claim 1, further comprising:
a guide pin extending from the break link,
wherein as the seat transitions from the use position to the stowed position the guide pin engages with the one or more rear links to alter rotation of the break link.

8. The seat of claim 1, wherein the break link is laterally offset from the one or more rear links across a width of the seat bottom.

9. The seat of claim 8, the one or more rear links comprising a first rear link and a second rear link, wherein each of the first rear link, the second rear link, and the break link are laterally offset such that each of the first rear link, the second rear link, and the break link are coupled to the seat bottom at different locations along the width of the seat bottom.

10. The seat of claim 1, wherein the rear link pivot point is vertically offset from the second pivot point.

11. The seat of claim 1, wherein the supporting linkage moves the seat in a non-uniform path comprising a substantially vertical section between the use position and the stowed position.

12. A stowable vehicle seat comprising:
a seat; and
a supporting linkage configured to transition the seat between a use position and a stowed position, the supporting linkage comprising:
a first rear link and a second rear link, each of the first and second rear links pivotably coupled to the seat and configured to pivotably couple to a vehicle floor;
a first break link pivotably coupled to the seat at a first pivot point;
a second break link pivotably coupled to the first break link and configured to pivotably couple to the vehicle floor at a second pivot point; and
a distance between the first pivot point and the second pivot point defining a virtual link, wherein a length of the virtual link changes as the seat transitions between the use position and the stowed position.

13. The seat of claim 12, wherein a change in length of the virtual link causes a path of the seat between the use position and the stowed position to be non-uniform.

14. The seat of claim 12, further comprising:
one or more springs biasing at least one of the first rear link or the second rear link towards the use position.

15. The seat of claim 14, wherein a force of the one or more springs is greater than a weight of the seat.

16. The seat of claim 12, wherein each of the first rear link, the second rear link, and the first break link are laterally offset such that each of the first rear link, the second rear link, and the first break link are coupled to the seat at different locations along a width of the seat.

17. The seat of claim 12, further comprising:
a guide pin extending away from the second break link, wherein the guide pin laterally overlaps one of the first rear link or the second rear link.

18. A method of stowing a vehicle seat comprising:
providing a seat coupled to a floor of a vehicle via a supporting linkage comprising:
one or more rear links pivotably coupled to the seat and pivotably coupled to the floor at a rear link point; and
a break link pivotably coupled at a first end to the seat at a first pivot point and pivotably couple at a second end to the floor at a second pivot point; and
applying a force to seat to transition the seat from a use position to a stowed position,
wherein a distance between the first pivot point and the second pivot point changes as the seat moves between the use position and the stowed position.

19. The method of claim 18, further comprising:
one or more springs coupled to the one or more rear links applying a spring force to bias the one or more rear links towards the use position, wherein the force is greater than the spring force.

20. The method of claim 18, wherein a path of the seat from the use position to the stowed position is non-uniform and comprises a substantially vertical portion proximate the stowed position.
